(19) United States
(12) Patent Application Publication
(10) Pub. No.: US 2016/0215700 A1
(43) Pub. Date: Jul. 28, 2016

(54) INNER FIXED STRUCTURE ACOUSTIC PANEL WITH DIRECTIONAL PERFORATIONS

(71) Applicant: ROHR, INC., Chula Vista, CA (US)

(72) Inventors: JIA YU, San Diego, CA (US); SONG CHIOU, Irvine, CA (US)

(73) Assignee: ROHR, INC., Chula Vista, CA (US)

(21) Appl. No.: 14/604,233

(22) Filed: Jan. 23, 2015

(51) Int. Cl. F02C 7/24; B64C 7/02; G10K 13/00

(52) U.S. Cl. CPC F02C 7/24; G10K 13/00; B64C 7/02

(57) ABSTRACT

A nacelle may comprise an acoustic panel in an inner fixed structure. The acoustic panel may comprise a top sheet having elongated perforations oriented in a circumferential direction. A low drag liner may be coupled to the top sheet. The orientation of the elongated perforations may result in a greater hoop strength for the top sheet as compared to a top sheet of similar thickness and percent open area having circular perforations.

### FIELD

The present disclosure relates to turbine engine systems and, more specifically, to acoustic panels in gas turbine engines.

### BACKGROUND

Acoustic panel construction is commonly used on aircraft components to provide structural elements where noise attenuation is also desired. Acoustic panels commonly comprise a non-perforated backskin, a honeycomb or other shape core, and a perforated top sheet. The core forms one or more resonator chambers which are open through the perforations in the top sheet. The acoustic panels may be utilized in various locations in a nacelle for a gas turbine engine, such as in the inlet, in the inner fixed structure, or in the exhaust center body.

Using a wire mesh or perforated film over the perforated top sheet has been shown to decrease drag on air flowing over the perforated top sheet. However, introducing the wire mesh or perforated film may change the acoustic properties of the acoustic panel, and in some cases the size of the perforations in the top sheet may be increased to maintain the desired acoustic properties. In locations where the acoustic liner is subjected to significant stress, the thickness of the top sheet may be increased to counteract a decrease in strength caused by the increased perforation size. However, increasing the thickness may result in added weight, package size, and cost to the acoustic panel.

### SUMMARY

An inner fixed structure at least partially defining a bypass air duct for a nacelle may comprise a backskin, a top sheet, and a core. The top sheet may comprise a plurality of elongated perforations oriented in a circumferential direction. The core may be located between the backskin and the top sheet.

In various embodiments, the inner fixed structure may comprise a wire mesh coupled to the top sheet. The inner fixed structure may comprise a perforated film coupled to the top sheet. A shape of the plurality of elongated perforations may comprise at least one of an oval, a rectangle, or a rectangle having semicircular ends. The plurality of elongated perforations may be located aft of a fan in the nacelle. The backskin, the top sheet, and the core may form an acoustic panel. A length of the plurality of elongated perforations may be greater than a width of the plurality of elongated perforations. A length of the plurality of elongated perforations may be between 0.4 inches-1.0 inches (1.0 cm-2.5 cm).

A nacelle for a gas turbine engine may comprise a translating sleeve and an inner fixed structure. The translating sleeve and the inner fixed structure may define a bypass air duct. The inner fixed structure may comprise a plurality of elongated perforations oriented in a circumferential direction about an axis of the nacelle.

In various embodiments, the nacelle may comprise a low drag liner coupled to the inner fixed structure. The low drag liner may comprise at least one of a wire mesh or a perforated film. The plurality of elongated perforations may be located in a top sheet of an acoustic panel. The plurality of elongated perforations may be oriented to maintain hoop strength. A percent open area of the top sheet may be between 10%-30%. A shape of the plurality of elongated perforations may comprise at least one of an oval, a rectangle, or a rectangle having semicircular ends.

An acoustic panel for a nacelle may comprise a non-perforated back skin, a perforated top skin, a core located between the non-perforated back skin and the perforated top skin, a plurality of elongated perforations in the perforated top skin, and at least one of a wire mesh or a microperforated film coupled to the perforated top skin.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a cross-section view of a nacelle in accordance with various embodiments;

FIG. 2 illustrates a perspective view of a prior art acoustic panel in accordance with various embodiments;

FIG. 3 illustrates a cross-section view of an acoustic panel in accordance with various embodiments;

FIG. 4 illustrates a perspective view of an inner fixed structure in accordance with various embodiments; and

FIG. 5 illustrates a plurality of example elongated perforations in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented.

Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

A nacelle for a gas turbine engine may comprise an inner fixed structure. The inner fixed structure may comprise an acoustic panel having a perforated top sheet. The perforations may be elongated and oriented in a circumferential direction. The shape and orientation of the perforations may improve a hoop strength of the top sheet relative to circular perforations. A wire mesh or perforated film may be coupled to the top sheet to reduce drag.

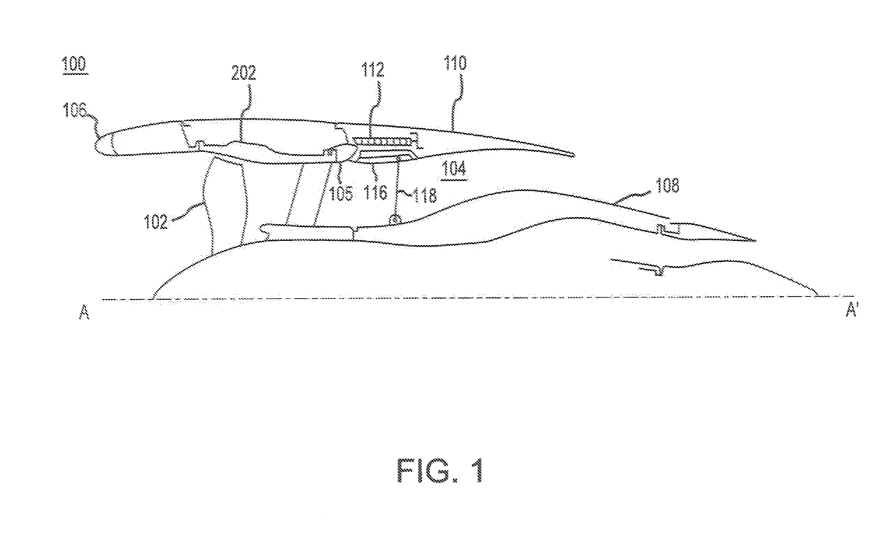

As used herein, “aft” refers to the direction associated with the tail (e.g., the back end) of an aircraft, or generally, to the direction of exhaust of the gas turbine. As used herein, “forward” refers to the directed associated with the nose (e.g., the front end) of an aircraft, or generally, to the direction of flight or motion. For example, with reference to FIG. 1, point A is forward of point A′along axis A-A′.

Referring to FIG. 1, a partial cross-section of a jet aircraft propulsion system nacelle 100 is shown. The nacelle 100 may extend from forward to aft along the axis A-A′. In flight, air from point A may flow around and/or through the nacelle 100 generally in the direction from point A to point A′.

The nacelle 100 may generally function to package a gas turbine engine and a fan or turbofan 102, and may guide air around the external portion of the nacelle 100 and internally through the nacelle 100 to define the bypass air duct 104.

The nacelle 100 may include an inlet 106 through which air may enter the nacelle 100. Some portion of airflow may enter the gas turbine engine, and some portion of airflow may flow through the bypass air duct 104. An inner fixed structure (“IFS”) 108 may define an inner airflow surface of the bypass air duct 104 and may be disposed coaxially about the gas turbine engine. The gas turbine engine may burn a hydrocarbon fuel in the presence of compressed air to generate exhaust gas. The exhaust gas may drive a turbine, which may, through a shaft, drive the fan 102 at the forward portion of the nacelle 100. The fan 102 may rotate to generate bypass fan airflow in a bypass air duct 104. The air flowing through the inlet 106 may flow in an axial direction. However, aft of the fan 102, the direction of airflow may vary in multiple directions.

The nacelle 100 may further comprise a thrust reversing assembly or a thrust reverser. The thrust reversing assembly may comprise a plurality of thrust reversing components, including, for example, a translating sleeve 110, a cascade 112, one or more blocker doors 116, and/or one or more drag links 118. The blocker door 116 may be coupled to the IFS 108 by the drag link 118.

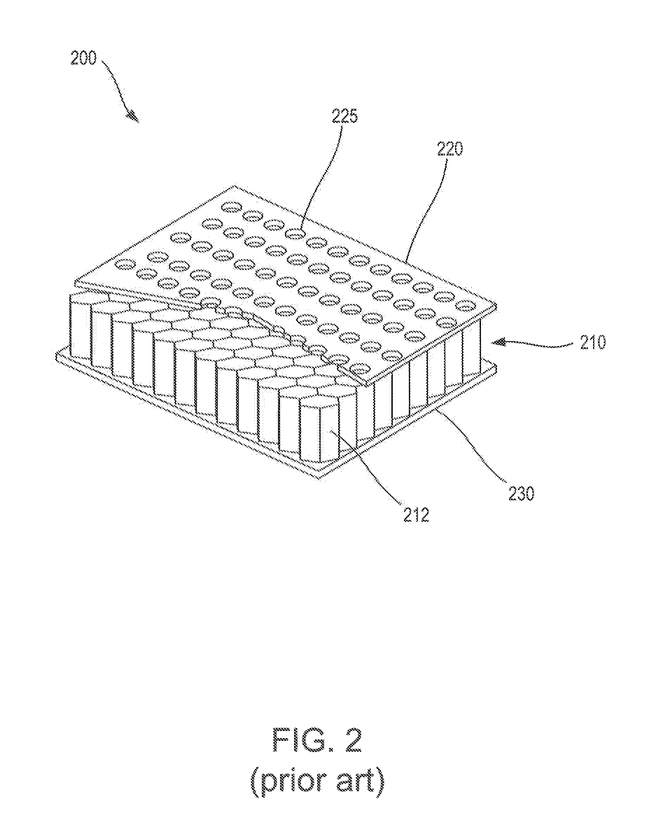

Referring to FIG. 2, a prior art acoustic panel 200 is illustrated according to various embodiments. The acoustic panel 200 may be an acoustic panel in a nacelle for an aircraft engine. Various portions of the nacelle may comprise an acoustic panel, such as the inner fixed structure. The acoustic panel 200 may comprise a core 210, positioned between a perforated top sheet 220 and a backskin 230. The core 210 may comprise a plurality of cells 212. The bottom of the acoustic panel 200 may be closed by a generally rigid non-perforated plate referred to herein as the backskin 230. A perforated top sheet 220 having perforations 225 may be coupled to the top of the acoustic panel 200. Additional layers may be formed on top of the perforated top sheet 220 for airflow and/or acoustic properties as desired. At least one of the perforated top sheet 220 or the backskin 230 may comprise a composite material. The perforated top sheet 220, core 210, and backskin 230 combine to form cells 212 that become resonator chambers and work to attenuate acoustic waves, such as noise from an aircraft engine, in a known fashion. The perforations 225 are configured to attenuate an engine's noise by directing the sound into the cells 212 of the acoustic panel 200 to allow reflected noise to destructively interfere with and cancel source noise. The acoustic panel 200 may attenuate sound waves at certain frequency ranges depending on the percent open area (“POA”) and diameter of the perforations 225, the core height of the cells 212, the volume of the resonator chamber or cell 212, the thickness of the perforated top sheet 220, etc. The POA is the ratio of the surface area of the perforations 225 relative to the surface area of the perforated top sheet 220. In various embodiments, the acoustic panel 200 may comprise one or more septum caps within the cells 212.

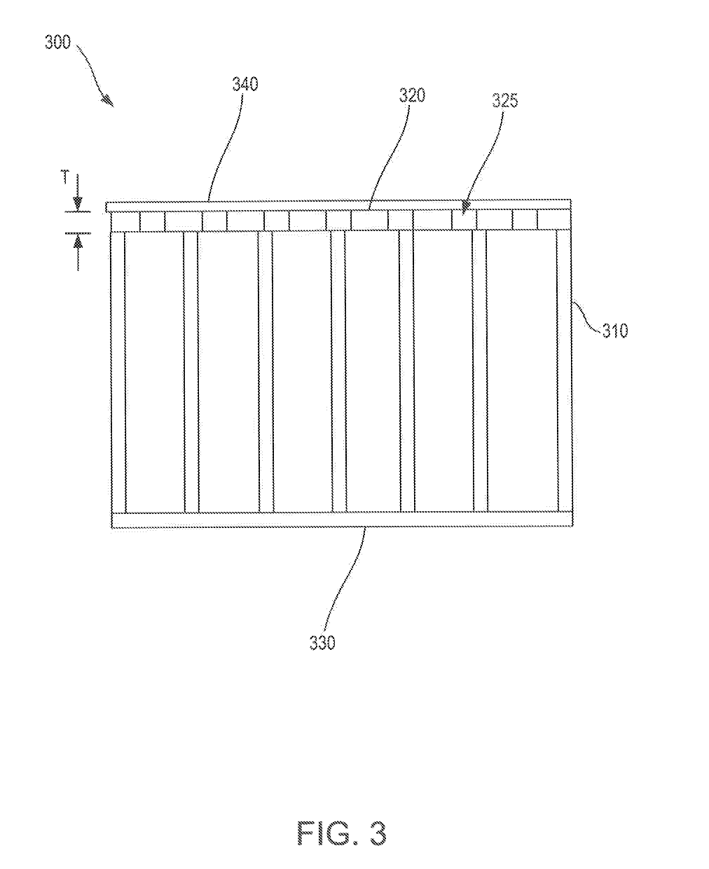

Referring to FIG. 3, a cross-section view of an acoustic panel 300 is illustrated according to various embodiments. The acoustic panel 300 may comprise a perforated top sheet 320, a core 310, and a backskin 330. The acoustic panel 300 may further comprise a low drag liner 340 coupled to the top sheet 320. In various embodiments, the low drag liner 340 may comprise at least one of a wire mesh or a microperforated film. The microperforated film may comprise a polymeric film or a carbon film having a POA of between 3%-30%. The low drag liner 340 may decrease drag between the airflow through the bypass air duct and the top sheet 320. However, the low drag liner 340 may also decrease the effective POA of the acoustic panel 300, because the low drag liner 340 may cover portions of the perforations 325. The effective POA may be calculated by multiplying the POA of the top sheet 320 by the POA of the low drag liner 340. For example, if the top sheet 320 comprises a 20% POA, and the low drag liner 340 comprises a 50% POA, the effective POA would be 10%. In various embodiments, the POA of the top sheet 320 may be between 10%-30%, (or 10-60 CGS rayls on DC flow resistance measured at 105 cm/sec, with NLF between 1-2.5, where NLF is nonlinear factor defined by the ratio of DC flow resistance measured at 200 cm/sec and 20 cm/sec). In order to achieve an equivalent POA compared to an acoustic panel without a low drag liner, a diameter of the perforations 325 may be increased. However, increasing the diameter of the perforations 325 may decrease the strength of the top sheet 320. A thickness T of the top sheet 320 may be increased in order to meet desired strength properties. Increasing the thickness T may result in an undesirable increase in the weight of the top sheet 320.

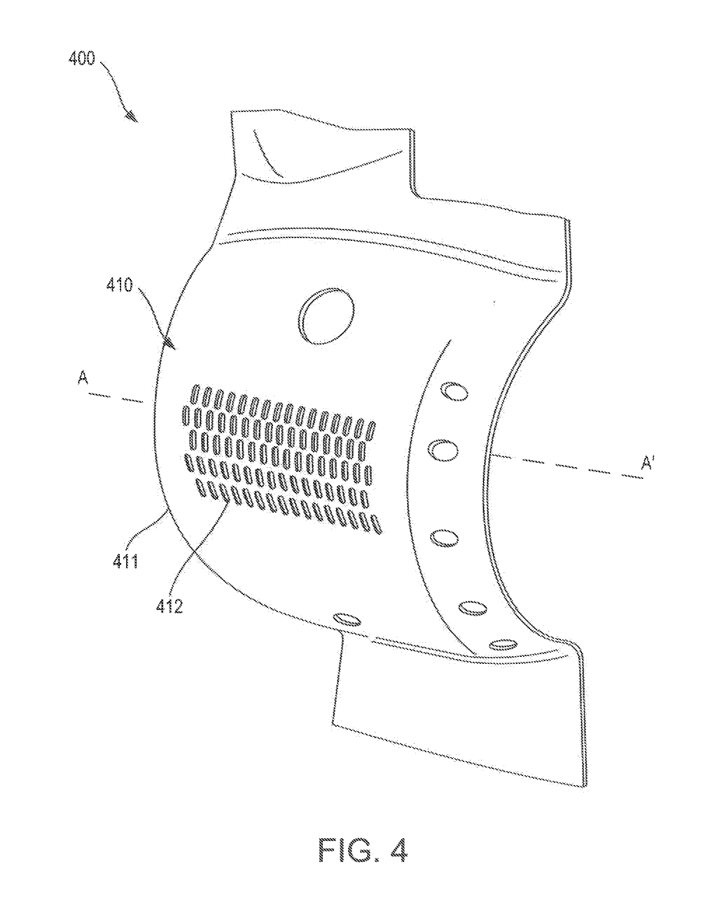

Referring to FIG. 4, a perspective view of an IFS 400 is illustrated according to various embodiments. The IFS 400 may experience loads from a variety of sources, such as from pressure in the bypass air duct, thermal loads, and pressure from a burst duct in an engine located within the IFS 400. The IFS 400 may be subjected to a load in the circumferential direction about the axis A-A′ (also referred to as “hoop load”). The hoop load resulting from a burst engine duct may cause the IFS 400 to crack or otherwise fail if not properly accounted for in the design, and is often a driving load case for the design.

In various embodiments, the IFS 400 may comprise an acoustic panel 410. The acoustic panel 410 may comprise a top sheet 411 comprising perforations 412. The perforations 412 are illustrated larger than scale for ease of illustration. In various embodiments, the perforations 412 may be elongated perforations. As used herein, an elongated perforation is a perforation having a length greater than a width. In various embodiments, the perforations 412 may be oriented in a circumferential direction. As used herein, oriented in a circumferential direction refers to a perforation which has a length in the circumferential direction which is greater than a width in the axial direction.

The airflow direction aft of the fan may be oriented in many directions. Thus, although it may be beneficial for drag characteristics for the perforations 412 to be aligned with a direction of the airflow, it may be difficult or impossible to align the perforations 412 with the localized airflow over the IFS 140. Therefore, as compared to areas with laminar airflow, such as in the inlet, the drag characteristics of the perforations 412 may be less important, and the perforations 412 may be oriented normal to a bulk direction of airflow through the IFS 140.

The perforations 412 may decrease the strength of the top sheet 411 due to the decrease in the amount of material in the top sheet 411. However, by orienting elongated perforations in a circumferential direction, the top sheet 411 may have a greater hoop strength and be able to withstand greater hoop stresses than a top sheet with a similar POA and circular perforations or perforations oriented in an axial direction. Thus, a low drag liner may be utilized with the acoustic panel 410 without increasing the thickness and weight of the top sheet by using a top sheet having elongated perforations oriented in the circumferential direction.

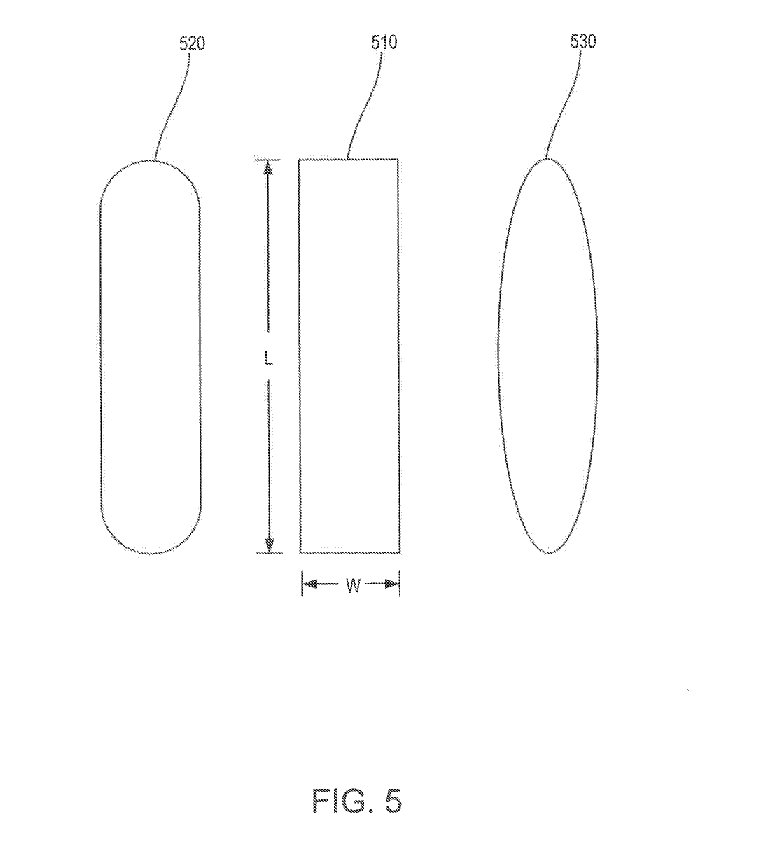

Referring to FIG. 5, various shapes of example elongated perforations are illustrated according to various embodiments. For example, the elongated perforations may comprise rectangular perforations 510. In various embodiments, the elongated perforations may comprise rectangular perforations with semicircular ends 520. In various embodiments, the elongated perforations may comprise an oval shape 530. In various embodiments, the elongated perforations may comprise a length L perpendicular to the axial direction which is greater than a width W in the axial direction. In various embodiments, the length L may be between 0.4 inches-1.0 inches (1.0 cm-2.5 cm), or between 0.1 inches-3 inches (0.25 cm-7.6 cm). In various embodiments, the width W may be 0.1 inches-0.3 inches (0.25 cm-0.76 cm), or between 0.01 inches-1.0 inches (0.025 cm-2.5 cm). However, those in the art will appreciate that any suitable dimensions may be designed for specific applications. The acoustic panels described herein provide both desirable acoustic properties as well as a surface mesh or film in an aero smooth condition.

Although described herein with reference to an inner fixed structure in an aircraft nacelle, the present disclosure may be utilized in any environment in which increased percent open area and increased hoop strength are desired.

In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. Furthermore, the connecting lines shown in the various figures contained herein are intended to represent various functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. An inner fixed structure at least partially defining a bypass air duct for a nacelle, the inner fixed structure comprising:
a backskin;
a top sheet comprising a plurality of elongated perforations oriented in a circumferential direction; and
a core located between the backskin and the top sheet.

2. The inner fixed structure of claim 1, further comprising a wire mesh coupled to the top sheet.

3. The inner fixed structure of claim 1, further comprising a perforated film coupled to the top sheet.

4. The inner fixed structure of claim 1, wherein a shape of the plurality of elongated perforations comprises at least one of an oval, a rectangle, and a rectangle having semicircular ends.

5. The inner fixed structure of claim 1, wherein the plurality of elongated perforations are located aft of a fan in the nacelle.

6. The inner fixed structure of claim 1, wherein the backskin, the top sheet, and the core form an acoustic panel.

7. The inner fixed structure of claim 1, wherein a length of the plurality of elongated perforations is greater than a width of the plurality of elongated perforations.

8. The inner fixed structure of claim 1, wherein a length of the plurality of elongated perforations is 0.4 inches-1.0 inches.

9. A nacelle for a gas turbine engine comprising:
a translating sleeve; and
an inner fixed structure, wherein the translating sleeve and the inner fixed structure define a bypass air duct, and wherein the inner fixed structure comprises a plurality of elongated perforations oriented in a circumferential direction about an axis of the nacelle.

10. The nacelle of claim 9, further comprising a low drag liner coupled to the inner fixed structure.

11. The nacelle of claim 10, wherein the low drag liner comprises at least one of a wire mesh or a perforated film.

12. The nacelle of claim 9, wherein the plurality of elongated perforations are located in a top sheet of an acoustic panel.

13. The nacelle of claim 9, wherein an orientation of the plurality of elongated perforations is selected to maintain hoop strength.

14. The nacelle of claim 12, wherein a percent open area of the top sheet is between 10%-30%.

15. The nacelle of claim 9, wherein a shape of the plurality of elongated perforations comprises at least one of an oval, a rectangle, and a rectangle having semicircular ends.

16. An acoustic panel for a nacelle comprising:
a non-perforated back skin;
a perforated top skin;
a core located between the non-perforated back skin and the perforated top skin;
a plurality of elongated perforations in the perforated top skin; and
at least one of a wire mesh or a microperforated film coupled to the perforated top skin.

17. The acoustic panel of claim 16, wherein the microperforated film comprises at least one of a polymeric film or a carbon film.

18. The acoustic panel of claim 16, wherein the acoustic panel is located in an inner fixed structure of the nacelle.

19. The acoustic panel of claim 16, wherein the plurality of elongated perforations are oriented in a circumferential direction.

20. The acoustic panel of claim 16, wherein the plurality of elongated perforations are configured to increase a hoop strength of the acoustic panel.
